(19) United States
(12) Patent Application Publication
(10) Pub. No.: US 2026/0322015 A1
(43) Pub. Date: Oct. 15, 2026

(54) MULTI-CORE COAXIAL CONNECTOR AND STRUCTURE COMPRISING THE SAME

(71) Applicant: JAPAN AVIATION ELECTRONICS INDUSTRY, LIMITED, Tokyo (JP)

(72) Inventors: Kazuhiko FURUKATSU, Tokyo (JP); Takashi TOKUNAGA, Tokyo (JP); Yuya KUBOTA, Tokyo (JP); Takashi NEMOTO, Tokyo (JP); Masaki ISHIGURO, Tokyo (JP)

(73) Assignee: JAPAN AVIATION ELECTRONICS INDUSTRY, LIMITED, Tokyo (JP)

(21) Appl. No.: 19/629,402

(22) Filed: Mar. 26, 2026

(30) Foreign Application Priority Data
Apr. 14, 2025 (JP) 2025-066139
Jul. 17, 2025 (JP) 2025-120774

(51) Int. Cl. H01R 12/81; H01R 24/40

(52) U.S. Cl. CPC H01R 12/81; H01R 24/40

(57) ABSTRACT

A multi-core coaxial connector comprises n component rows, n being a natural number of three or more. Each of the component rows comprises m or more coaxial components, m being a natural number of n or more. The coaxial components in each of the component rows are arranged linearly at a predetermined pitch along a predetermined direction perpendicular to a longitudinal direction of the coaxial component. In the predetermined direction, between a center of one of the coaxial components in one of the component rows and a center of another one of the coaxial components adjacent thereto in the same component row, a center of one of the coaxial components in each of all other component rows is located.

### CROSS REFERENCE TO RELATED APPLICATIONS

This application is based on and claims priority under 35 U.S.C. §119 to Japanese Patent Application No. JP 2025-120774 filed Jul. 17, 2025 and Japanese Patent Application No. JP 2025-066139 filed Apr. 14, 2025, the contents of which are incorporated herein in their entirety by reference.

### BACKGROUND OF THE INVENTION

This invention relates to a multi-core coaxial connector comprising three or more component rows and a structure comprising the multi-core coaxial connector.

For example, JP2011-517038A (Patent Document 1) discloses a multiple coaxial connector that enables a plurality of coaxial components to be collectively attached and detached. Referring to FIG. 18, the multiple coaxial connector 1300 of Patent Document 1 comprises a male connector module 1310 and a female connector module 1330. The male connector module 1310 includes a plurality of male connectors (coaxial components) 1340, to which coaxial cables 1400 are attached, respectively. These male connectors 1340 are fixed by a housing 1360 of the male connector module 1310 and are regularly arranged along a mating surface 1361 of the housing 1360. The female connector module 1330 also includes the same number of female connectors (coaxial components) 1350 as the male connectors 1340. The female connectors 1350 are respectively inserted into openings 1371 of a housing 1370 of the female connector module 1330 and are regularly arranged along a mating surface 1372 of the housing 1370. The female connector module 1330 is fixed to a mounting board (not shown in FIG. 18).

In the multiple coaxial connector 1300 of Patent Document 1, by mating the male connector module 1310 and the female connector module 1330 with each other along a Z-direction, the plurality of male connectors 1340 and the plurality of female connectors 1350 can be simultaneously connected to each other respectively.

### SUMMARY OF THE INVENTION

As described above, in the multiple coaxial connector 1300 of Patent Document 1, the coaxial cables 1400 are attached to the male connectors 1340, respectively. If the coaxial cables 1400 could be replaced with an FPC (Flexible Printed Circuit), a space required for installing a structure including the coaxial components could be reduced.

An object of exemplary embodiments of the present invention is to provide a multi-core coaxial connector having three or more components rows, which is suitable for using an FPC or the like in place of coaxial cables.

An aspect of the present invention provides a multi-core coaxial connector comprising n component rows, n being a natural number of three or more. Each of the component rows comprises m or more coaxial components, m being a natural number of n or more. The coaxial components in each of the component rows are arranged linearly at a predetermined pitch along a predetermined direction perpendicular to a longitudinal direction of the coaxial component. In the predetermined direction, between a center of one of the coaxial components in one of the component rows and a center of another one of the coaxial components adjacent thereto in the same component row, a center of one of the coaxial components in each of all other component rows is located.

Another aspect of the present invention provides a structure comprising an FPC and two multi-core coaxial connectors, each of which is the multi-core coaxial connector described above. The FPC comprises a plurality of signal lines formed on a common layer and has one of a stripline structure, a microstrip line structure, or a coplanar line structure. The coaxial components included in each of the multi-core coaxial connectors comprise signal members, insulators, and ground members, respectively. The signal members of the coaxial components included in one of the two multi-core coaxial connectors are respectively connected to the signal members of the coaxial components included in a remaining one of the two multi-core coaxial connectors via the signal lines of the FPC.

Still another aspect of the present invention provides another structure comprising a mounting board, a plurality of connector assemblies, and a plurality of FPCs. Each of the plurality of connector assemblies comprises the multi-core coaxial connector described above and a mating connector thereof. The mating connectors of the connector assemblies are fixed on the mounting board. In each of the connector assemblies, the multi-core coaxial connector is mated with the mating connector. The plurality of FPCs are connected to the multi-core coaxial connectors, respectively. The plurality of FPCs at least partially overlap each other and are arranged in proximity to each other.

According to the present invention, on a substrate to which a multi-core coaxial connector is mounted or connected, a plurality of signal lines connected to the multi-core coaxial connector can be arranged in parallel on a common layer. Accordingly, the multi-core coaxial connector of the present invention can be connected to an FPC.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a multi-core coaxial connector according to a first embodiment of the present invention.

FIG. 2 is a front view showing the multi-core coaxial connector of FIG. 1.

FIG. 3 is a top view showing the multi-core coaxial connector of FIG. 1.

FIG. 4 is a bottom view showing the multi-core coaxial connector of FIG. 1.

FIG. 5 is a cross-sectional view showing the multi-core coaxial connector of FIG. 3, taken along line V–V.

FIG. 6 is a perspective view showing a mating connector that mates with the multi-core coaxial connector shown in FIG. 1.

FIG. 7 is a front view showing the mating connector of FIG. 6.

FIG. 8 is a top view showing the mating connector of FIG. 6.

FIG. 9 is a bottom view showing the mating connector of FIG. 6.

FIG. 10 is a cross-sectional view showing the mating connector of FIG. 9, taken along line X–X.

FIG. 11 is a perspective view showing a connector assembly including the multi-core coaxial connector of FIG. 1.

FIG. 12 is a front view of the connector assembly of FIG. 11, showing a separated state in which a first connector and a second connector are spaced apart from each other.

FIG. 13 is a front view showing a structure according to a second embodiment of the present invention.

FIG. 14 is a side view showing the structure of FIG. 13.

FIG. 15 is a rear view showing an example of an FPC included in the structure of FIG. 13.

FIG. 16 is a cross-sectional view showing the FPC of FIG. 15, taken along line XVI–XVI.

FIG. 17 is a side view showing a structure according to a third embodiment of the present invention.

FIG. 18 is a perspective view showing a multiple coaxial connector disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

A multi-core coaxial connector 2 according to an embodiment of the present invention and structures 101 and 102 including the multi-core coaxial connector 2 will be described below with reference to the drawings. In the drawings, the same or similar elements are denoted by the same or similar reference numerals and designations. Repetitive descriptions of the same or similar elements may be omitted in the description of the embodiment. The structures shown in the drawings are merely illustrative for explaining the embodiment, and the structure of the connector shown in the drawings may be modified or changed without causing technical problems.

### First embodiment

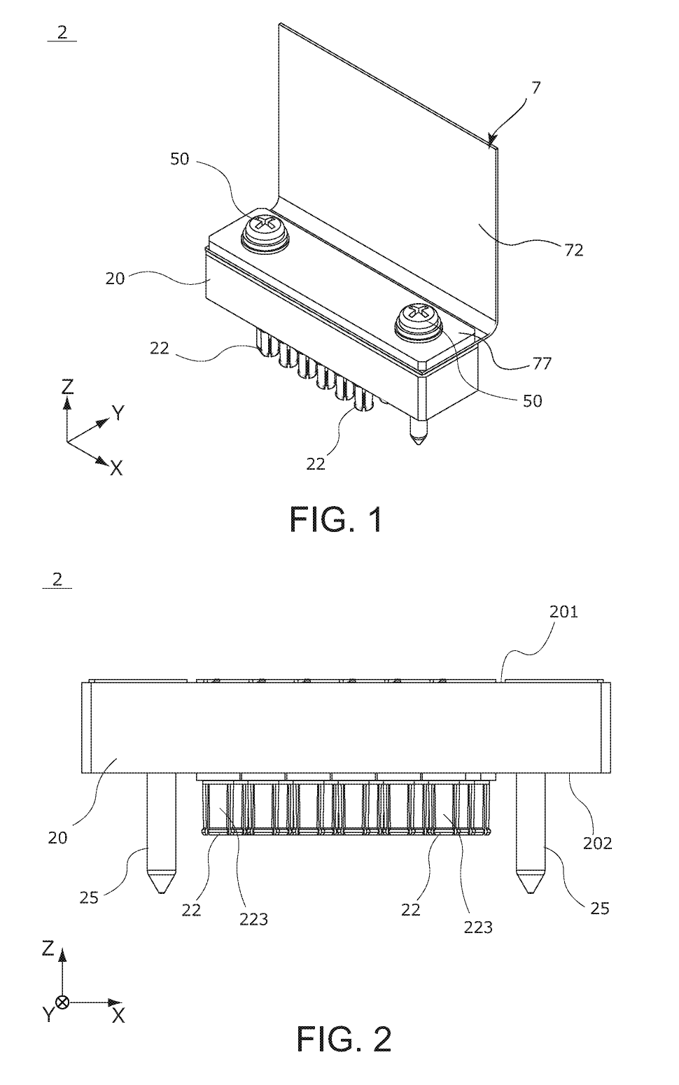

Referring to FIG. 1, the multi-core coaxial connector 2 according to a first embodiment of the present invention is a connector that is connectable to an FPC (Flexible Printed Circuit). The multi-core coaxial connector 2 is mated with a mating connector 4 fixed to a mounting board 8 as shown in FIG. 6. In the present embodiment, the mating direction is a Z-direction. Here, a positive Z-direction (+Z) is defined as an upward direction, and a negative Z-direction (-Z) is defined as a downward direction.

Referring to FIGS. 1 and 2, the multi-core coaxial connector 2 includes a ground housing 20 and a plurality of coaxial components 22.

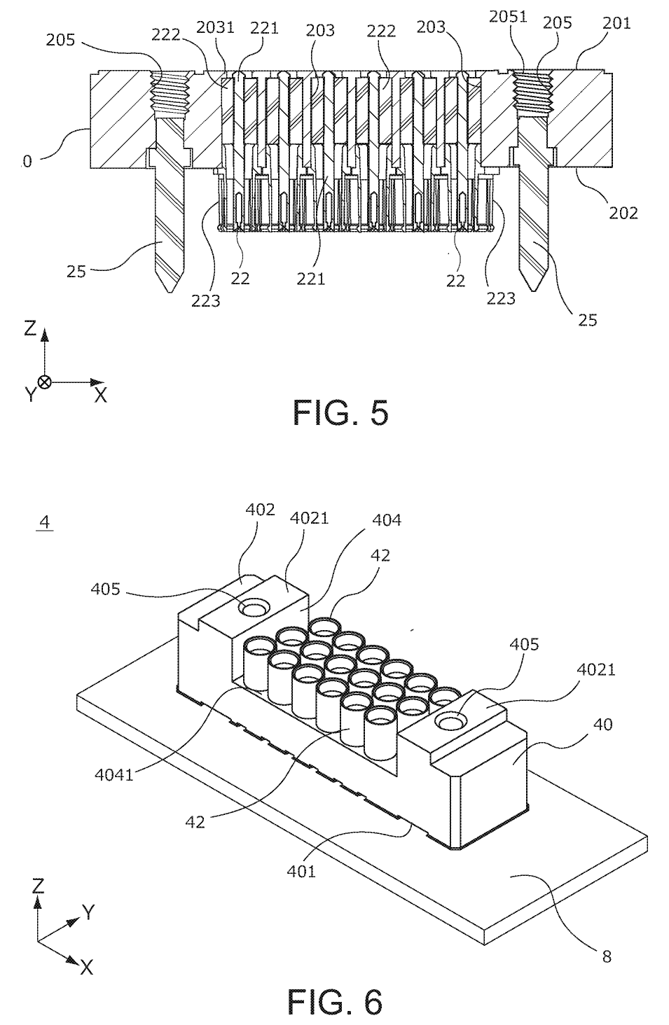

The ground housing 20 is a conductor having a substantially rectangular parallelepiped shape. As shown in FIG. 5, the ground housing 20 has a plurality of openings 203. Each of the openings 203 is a through hole that penetrates the ground housing 20 along the mating direction or the Z-direction. The openings 203 are open to the exterior of the ground housing 20 at an upper surface of the ground housing 20 or a connection surface 201 facing the positive Z-direction and at a bottom surface of the ground housing 20 or a mating surface 202 facing the negative Z-direction. Each of the openings 203 has a substantially circular shape in a plane perpendicular to the mating direction. Each of the openings 203 has a diameter on the connection surface 201 and a diameter on the mating surface 202, the former being smaller than the latter. Each of the openings 203 has a stopper portion 2031 at an end portion thereof on or near the connection surface 201, the stopper portion 2031 projecting toward a center of the opening 203 in the plane perpendicular to the mating direction. Each of the openings 203 accommodates one of the coaxial components 22, and the stopper portion 2031 receives a part of an end portion of the coaxial component 22 in the positive Z-direction.

The ground housing 20 further has two through holes 205 located in an X direction outside a region in which the openings 203 are formed. Each of the through holes 205 penetrates the ground housing 20 along the mating direction. In each of the through holes 205, a helical screw groove 2051 is formed on an inner surface of an upper portion thereof. A positioning pin 25 is partially inserted into a lower portion of each of the through holes 205 below the screw groove 2051. Each positioning pin 25 has a pin shape and partially extends from the mating surface 202 downwards. The ground housing 20 functions as an outer shell member that holds the plurality of coaxial components 22.

As shown in FIGS. 4 and 5, each of the coaxial components 22 is a substantially cylindrical contact component extending along the mating direction. A longitudinal direction of the coaxial component 22 coincides with the mating direction of the multi-core coaxial connector 2. The coaxial components 22 are inserted into the openings 203, respectively, and fixed within the openings 203, respectively. A part of each coaxial component 22 protrudes from the mating surface 202 of the ground housing 20 downwards. In the mating direction, a protrusion length of the coaxial component 22 from the mating surface 202 to an end portion thereof in the negative Z-direction is shorter than a protrusion length of the positioning pin 25 from the mating surface 202 to an end portion thereof in the negative Z-direction. In other words, the negative Z-directional end portion of the positioning pin 25 is positioned lower than the negative Z-directional end portion of the coaxial component 22.

As shown in FIG. 5, each of the coaxial components 22 includes a signal member 221, an insulator 222, and a ground member 223. In each of the coaxial components 22, the signal member 221 is a socket-shaped contact extending along the mating direction. An end portion of the signal member 221 in the positive Z-direction is exposed to the exterior of the ground housing 20 on the connection surface 201. An end portion of the signal member 221 in the negative Z-direction is positioned below the mating surface 202 and is accommodated inside the ground member 223 in the plane perpendicular to the mating direction.

In each of the coaxial components 22, the insulator 222 is a holding member that holds the signal member 221 and is accommodated inside the opening 203 of the ground housing 20. An end portion of the insulator 222 toward the positive Z-direction is in contact with the stopper portion 2031 of the opening 203, and an end portion of the insulator 222 toward the negative Z-direction is in contact with the ground member 223. In other words, the insulator 222 is fixed within the opening 203 by being sandwiched between the stopper portion 2031 and the ground member 223. In each of the coaxial components 22, the insulator 222 fixes the signal member 221 and electrically insulates the signal member 221 from the ground housing 20.

In each of the coaxial components 22, the ground member 223 is a conductor having a substantially cylindrical shape. An upper part of the ground member 223 is inserted into and fixed within the opening 203. By fixing a part of the ground member 223 to the ground housing 20 in this manner, the ground housing 20 is connected to the ground member 223 of each coaxial component 22. On the other hand, a lower part of the ground member 223 extends in the negative Z-direction beyond the mating surface 202. In the plane perpendicular to the mating direction, the ground member 223 surrounds the signal member 221 via an air layer. In each of the coaxial components 22, the signal member 221 and the ground member 223 are not electrically connected to each other. In the multi-core coaxial connector 2, the ground housing 20 and the ground members 223 of the coaxial components 22 function as a shield that shields an electric field around the signal members 221, thereby reducing influences of unwanted electromagnetic waves and noise from outside.

Referring to FIG. 4, the multi-core coaxial connector 2 has component rows CR, which are formed by arranging a plurality of coaxial components 22 in a matrix in the plane perpendicular to the mating direction, each of the component rows CR including coaxial components 22 arranged linearly. More specifically, the multi-core coaxial connector 2 includes three component rows CR. In each of the component rows CR, the coaxial components 22 are arranged linearly at a predetermined pitch along an X-direction perpendicular to the mating direction. Here, in the matrix arrangement of the coaxial components 22, a row direction is defined as a direction in which the coaxial components 22 linearly arranged at a constant pitch are largest in number, among a plurality of directions in which the coaxial components 22 arranged at a constant pitch. That is, in the multi-core coaxial connector 2 shown in FIG. 4, the X-direction is the row direction. Among the three component rows shown in FIG. 4, the component row CR located farthest in a negative Y-direction is referred to as a first row, the component row CR located at a middle position is referred to as a second row, and the component row CR located farthest in a positive Y-direction is referred to as a third row. The arrangements of the coaxial components 22 in the plurality of component rows CR are parallel to each other.

Although three component rows CR are illustrated in FIG. 4, the multi-core coaxial connector 2 may include n component rows, where n is a natural number of three or more, and the number of component rows is not necessarily limited. Although component rows each having six coaxial components 22 are illustrated in FIG. 4, each of the component rows CR may include m or more coaxial components 22, where m is a natural number of n or more, and the number of coaxial components 22 included in each of the component rows CR is not necessarily limited. The number of coaxial components 22 may be different among the component rows CR. Further, in the example shown in FIG. 4, the row direction of the arrangement of the coaxial components 22 coincides with a longitudinal direction of the mating surface 202 of the ground housing 20; however, the row direction is not particularly limited. The row direction of the arrangement of the coaxial components 22 may be different from the longitudinal direction of an outer surface of the ground housing 20.

In the multi-core coaxial connector 2, in the X-direction, between a center of one of the coaxial components 22 in one of the component rows CR and a center of another one of the coaxial components 22 adjacent thereto in the same component row CR, a center of one of the coaxial components 22 in each of all other component rows CR is located. Here, in each of the component rows CR, a coaxial component 22 located farthest in a negative X-direction is defined as a first coaxial component, and a coaxial component 22 located farthest in a positive X-direction is defined as a sixth coaxial component. Based on those definitions, the above arrangement feature will be described in detail. Within a region R1 between a center A1 of a first coaxial component 22A and a center A2 of a second coaxial component 22A in a first row, a center B1 of a first coaxial component 22B in a second row and a center C1 of a first coaxial component 22C in a third row are located in the X-direction. That is, each of the coaxial components 22 included in one of the component rows CR is arranged such that a position of the center of the coaxial component 22 in the X-direction does not overlap with positions of centers of the coaxial components 22 in the X-direction in the other component rows CR.

Note that, in each of the component rows CR, the coaxial components 22 are arranged at the same pitch. Accordingly, the same feature as that of the region R1 between the first and second coaxial components 22A in the first row also appears in regions between other adjacent coaxial components 22 in the first row, i.e., regions other than the region between the first and second coaxial components 22A. The same feature also appears in regions between adjacent coaxial components 22 in the other component rows, or the second row and the third row. For example, within a region R2 between a third coaxial component 22B and a fourth coaxial component 22B in the second row, a center A4 of a fourth coaxial component 22A in the first row and a center C3 of a third coaxial component 22C in the third row are located in the X direction. The same applies to a region R3 between a fifth coaxial component 22C and a sixth coaxial component 22C in the third row.

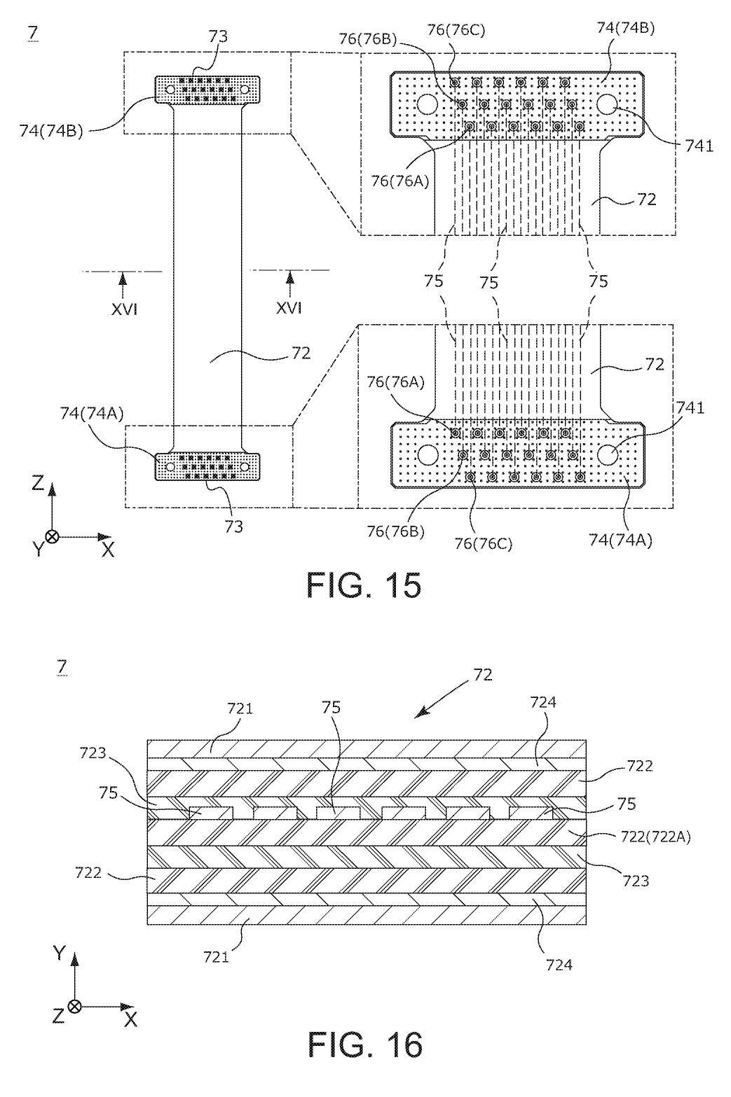

As described above, by arranging the coaxial components 22 in an arrangement that is different from both a parallel arrangement and a staggered arrangement, it is possible, on a substrate on which the multi-core coaxial connector 2 is mounted or connected, to route a plurality of signal lines connected to the multi-core coaxial connector 2 in parallel on a common layer. Accordingly, the multi-core coaxial connector 2 is connectable to an FPC 7 as shown in FIGS. 15 and 16.

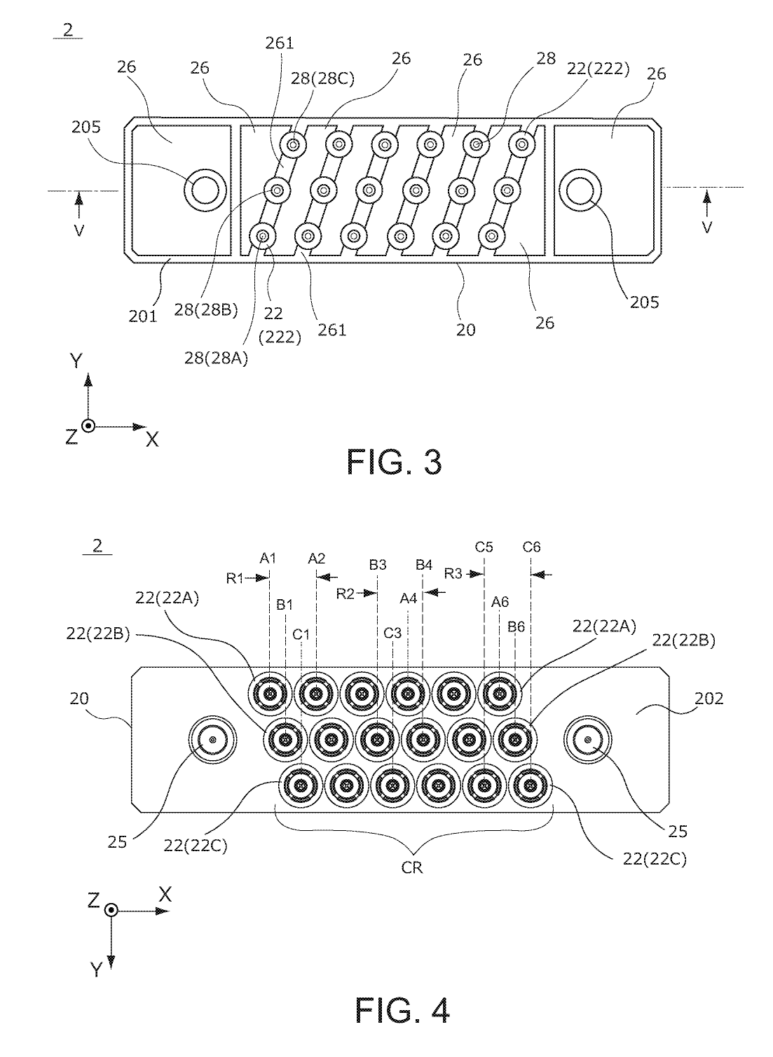

In the multi-core coaxial connector 2, the connection surface 201, which is formed as one surface of the ground housing 20, is connected to the substrate such as the FPC 7. As shown in FIG. 3, the connection surface 201 has a plurality of ground pads 26 and a plurality of signal pads 28 formed thereon. Each of the ground pads 26 is formed by the connection surface 201 as such. The ground pads 26 are connected to the ground members 223 of the coaxial components 22 via the ground housing 20. In other words, each of the ground members 223 is connected to at least one of the ground pads 26. On the other hand, each of the signal pads 28 is a tip portion of any one of the coaxial components 22 exposed on the connection surface 201. The signal pads 28 correspond to the coaxial components 22, respectively, and each of the signal pads 28 is connected to the signal member 221 of the corresponding coaxial component 22. That is, the signal member 221 of each coaxial component 22 is connected to a corresponding one of the signal pads 28. The insulators 222 of the coaxial components 22 are interposed between the ground pads 26 and the signal pads 28. Accordingly, the ground pads 26 and the signal pads 28 are electrically insulated from each other.

On the connection surface 201, adjacent ones of the plurality of ground pads 26 are located away from each other with a pad groove 261 left therebetween. In the Y-direction, each of the pad grooves 261 extends from one edge of the connection surface 201 to the other edge thereof. In other words, two adjacent ground pads 26 are separated by the pad groove 261 extending in the Y direction to opposite edges of the connection surface 201. Within each of the pad grooves 261, a signal pad 28A corresponding to one of the coaxial components 22A in the first row, a signal pad 28B corresponding to one of the coaxial components 22B in the second row, and a signal pad 28C corresponding to one of the coaxial components 22C in the third row are arranged. That is, with three signal pads 28 corresponding to one of the coaxial components 22 in each of the component rows as one set, the three signal pads 28 of one set are located within one of the pad grooves 261 between two ground pads 26.

By providing the pad grooves 261 extending to an edge of the connection surface 201 as described above, when the multi-core coaxial connector 2 is mounted on the substrate, gas generated from solder paste applied to the signal pads 28 can be released to the outside through the pad grooves 261. As a result, connection reliability between the multi-core coaxial connector 2 and the substrate such as the FPC 7 can be improved. In the example shown in FIG. 3, the pad groove 261 reaches both edges of the connection surface 201; however, a configuration in which the pad groove 261 reaches only one of the edges of the connection surface 201 may also be employed. Further, in the example shown in FIG. 3, each of the signal pads 28 is located within one of the pad grooves 261; however, it is sufficient that, within at least one of the pad grooves 261, n signal pads 28 corresponding to one of the coaxial components 22 in each of the n component rows are located. The connection surface 201 may include signal pads 28 that are not located within any of the pad grooves 261, or may include signal pads 28 that belong to a plurality of the pad grooves 261. Further, the connection surface 201 may be provided with pad grooves 261 that do not include any signal pads 28 therein.

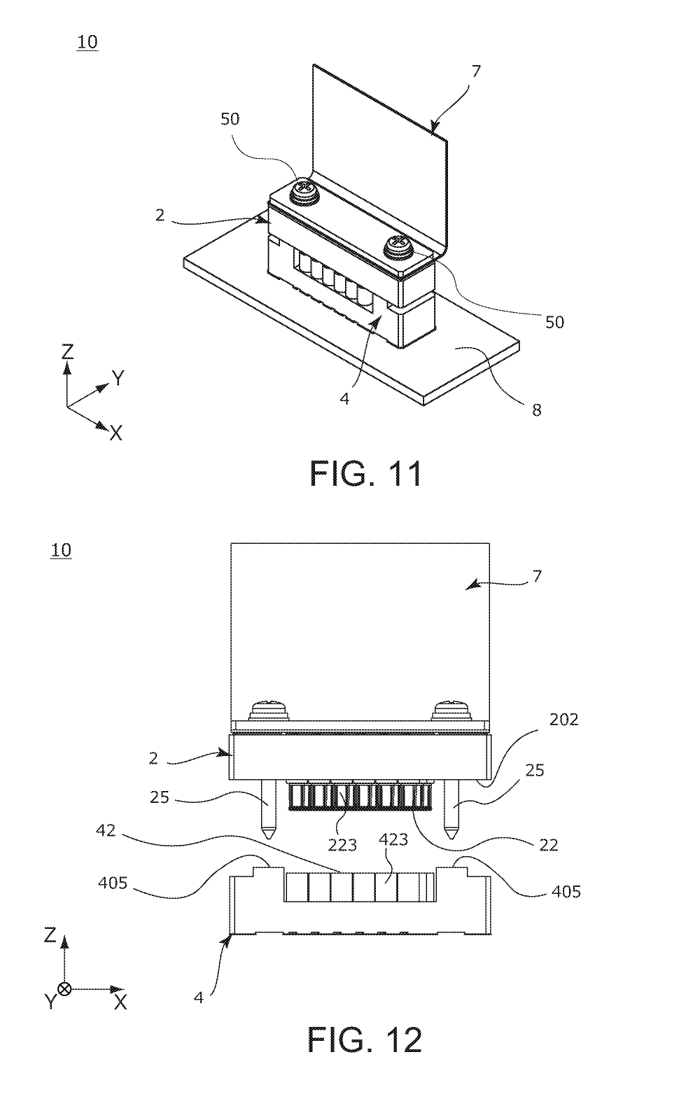

Referring to FIG. 11, the multi-core coaxial connector 2 mates with the mating connector 4 mounted on the mounting board 8 to form a connector assembly 10.

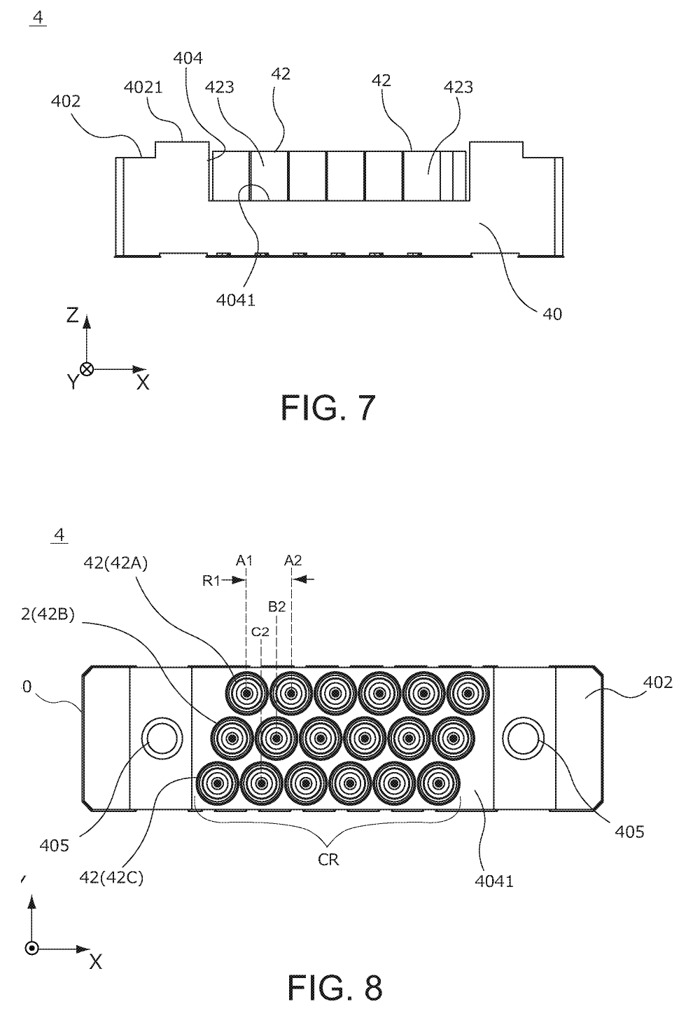

Referring to FIGS. 6 and 7, the mating connector 4 includes a mating ground housing 40 and a plurality of mating coaxial components 42.

The mating ground housing 40 is a conductor having a substantially rectangular parallelepiped shape. The mating ground housing 40 has a connection surface 401 facing the negative Z-direction and a mating surface 402 facing the positive Z-direction. The mating surface 402 of the mating ground housing 40 has a groove-shaped receiving portion 404 formed such that parts of opposite side surfaces of the mating ground housing 40, which is perpendicular to the Y-direction, are open. The mating ground housing 40 has protruding portions 4021 protruding in the positive Z-direction from the mating surface 402. As shown in FIG. 10, a through hole 405 is formed in each of the protruding portions 4021, the through hole 405 penetrating the mating ground housing 40 in the mating direction.

The mating ground housing 40 has a plurality of openings 403 in a region in which the receiving portion 404 is formed. Each of the openings 403 penetrates the mating ground housing 40 along the mating direction. The openings 403 accommodate the mating coaxial components 42, respectively. The mating ground housing 40 functions as an outer shell member that holds the mating coaxial components 42.

Each of the mating coaxial components 42 includes a mating signal member 421, a mating insulator 422, and a mating ground member 423, similarly to the coaxial components 22 of the multi-core coaxial connector 2. In each of the mating coaxial components 42, the mating signal member 421 is a pin-shaped contact extending along the mating direction and is held by the mating insulator 422. In each of the mating coaxial components 42, the mating insulator 422 is inserted into one of the openings 403 and is fixed within the opening 403, while holding the mating signal member 421. In each of the mating coaxial components 42, the mating ground member 423 is partially inserted into one of the openings 403. The mating ground housing 40 is connected to each of the mating ground members 423. An upper part of the mating ground member 423 extends in the positive Z-direction from an upper surface 4041 of the receiving portion 404 and is accommodated within the receiving portion 404.

Referring to FIG. 8, the mating coaxial components 42 of the mating connector 4 are arranged in the same manner as the coaxial components 22 of the multi-core coaxial connector 2. That is, the mating connector 4 includes the same number of mating coaxial components 42 as the coaxial components 22 of the multi-core coaxial connector 2, and includes three component rows CR in which the mating coaxial components 42 are arranged. In each of the component rows CR, the mating coaxial components 42 are arranged linearly at a predetermined pitch in the X-direction. The plurality of component rows CR are parallel to each other. Further, within a region R1 between a center A1 of a first mating coaxial component 42A and a center A2 of a second mating coaxial component 42A in a first row, a center B2 of a second mating coaxial component 42B in a second row and a center C2 of a second mating coaxial component 42C in a third row are located in the X direction.

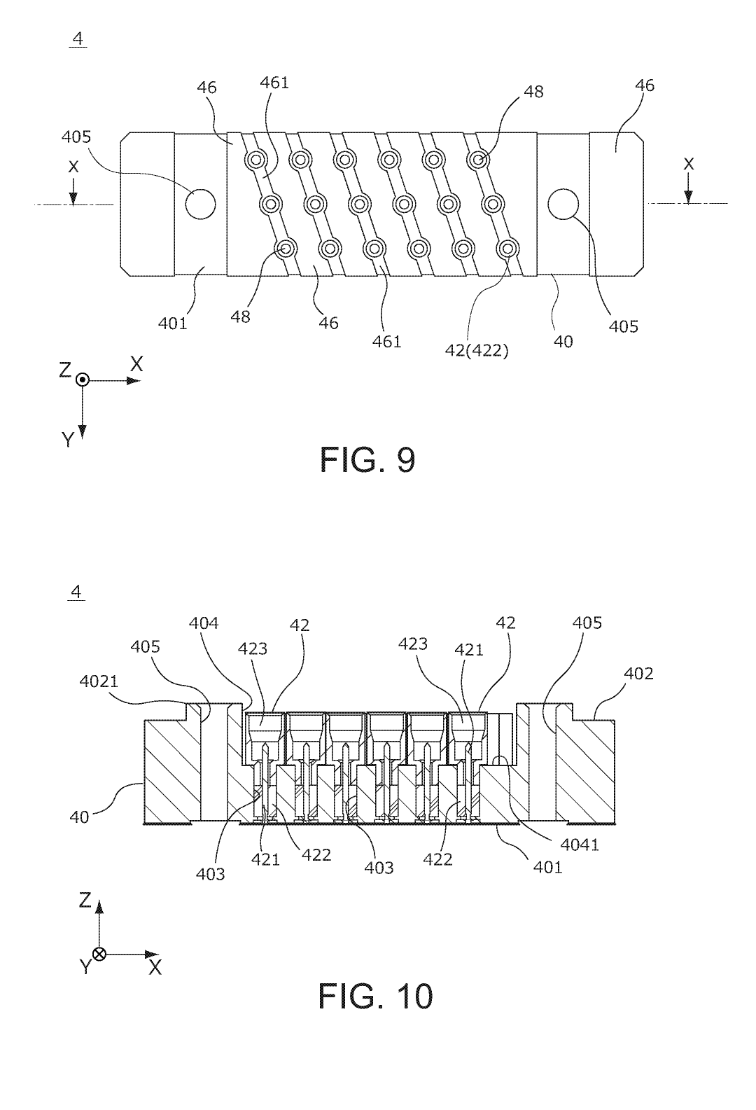

Referring to FIG. 9, a connection surface 401 of the mating connector 4 is one surface of the mating ground housing 40 that is fixed on the mounting board 8. On the connection surface 401, similarly to the connection surface 201 of the multi-core coaxial connector 2, a plurality of ground pads 46 and a plurality of signal pads 48 are formed. Also in the mating connector 4, adjacent ones of the plurality of ground pads 46 are located away from each other with a pad groove 461 left therebetween. In the Y-direction, each of the pad grooves 461 extends from one edge of the connection surface 401 to the other edge thereof. Within each of the pad grooves 461 on the connection surface 401, three signal pads 48 corresponding to one of the mating coaxial components 42 in each of the component rows are located. By forming the pad grooves 461 reaching at least one of the edges of the connection surface 401 in this manner, when the mating connector 4 is mounted on the mounting board 8, gas generated from solder paste applied to the signal pads 48 can be released to the outside through the pad grooves 461.

Referring to FIG. 12, when the multi-core coaxial connector 2 is mated with the mating connector 4, first, the positioning pins 25 of the multi-core coaxial connector 2 are inserted into the through holes 405 of the mating connector 4. When the positioning pins 25 are received in the through holes 405, the multi-core coaxial connector 2 is guided to a correct position relative to the mating connector 4 in a plane perpendicular to the mating direction. Then, the ground members 223 of the coaxial components 22 protruding in the negative Z-direction and the mating ground members 423 of the mating coaxial components 42 protruding in the positive Z-direction are respectively mated with each other. When the coaxial components and the mating coaxial components are thus mated with each other, respectively, the pin-shaped mating signal members 421 of the mating connector 4 are received by the socket-shaped signal members 221 of the multi-core coaxial connector 2 within a space surrounded by the ground members 223 and the mating ground members 423. As a result, the signal members 221 and the mating signal members 421 are electrically connected to each other.

### Second embodiment

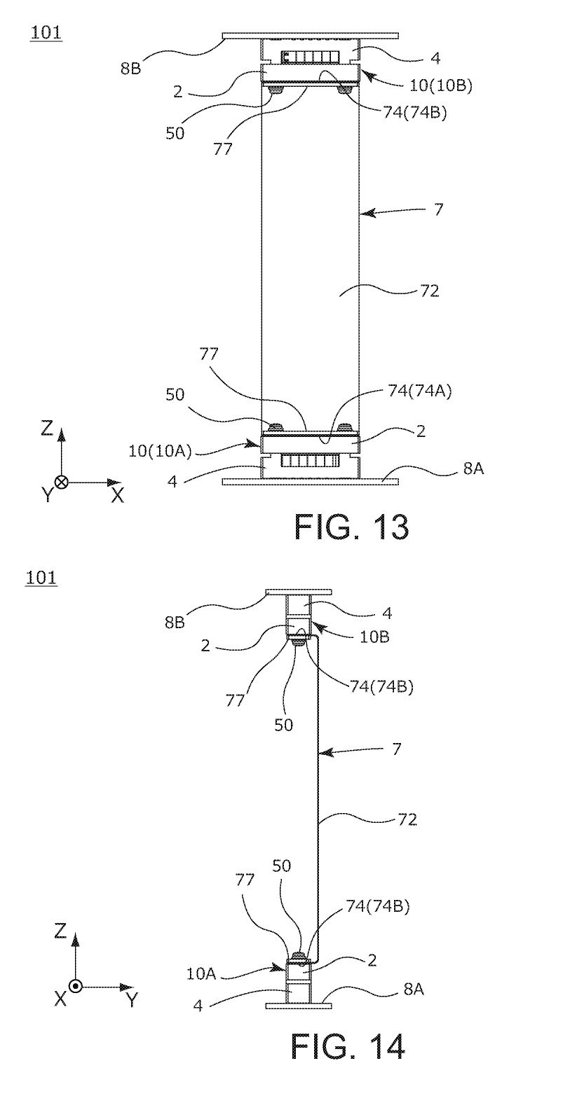

Referring to FIGS. 13 and 14, a structure 101 according to a second embodiment of the present invention includes two connector assemblies 10 shown in the above-described first embodiment and an FPC 7. In FIG. 13, one of the connector assemblies 10 located toward the negative Z-direction of the other is also referred to as a first connector assembly 10A, and the other connector assembly 10 located on the positive Z-direction of the first connector assembly 10A is also referred to as a second connector assembly 10B. The first connector assembly 10A is mounted on a first mounting board 8A, which is located on the negative Z-directional side of the first connector assembly 10A, by fixing the mating connector 4 to the first mounting board 8A. The second connector assembly 10B is mounted on a second mounting board 8B, which is located on the positive Z-directional side of the second connector assembly 10B, by fixing the mating connector 4 to the second mounting board 8B.

The FPC 7 is fixed to the multi-core coaxial connectors 2 of the respective connector assemblies 10 by screws 50, at both end portions thereof in the Z-direction. More specifically, the FPC 7 is connected to the multi-core coaxial connectors 2 by solder, and the screws 50 reinforce the connection between the FPC 7 and the multi-core coaxial connectors 2. Referring to FIG. 15, the FPC 7 includes a belt-shaped transmission portion 72 extending along the Z-direction, connector connection surfaces 74 located at both end portions of the transmission portion 72, and a plurality of signal lines 75 located inside the FPC 7. Each of the connector connection surfaces 74 is a surface that contacts the connection surface 201 of the multi-core coaxial connector 2. The connector connection surface 74 for the first connector assembly 10A is also referred to as a first connector connection surface 74A, and the connector connection surface 74 for the second connector assembly 10B is referred to as a second connector connection surface 74B. A reinforcing plate 73 is provided on a rear surface of each of the connector connection surfaces 74. Each of the connector connection surfaces 74 is formed with a plurality of connection pads 76 and holes 741 through which the screws 50 pass. Each of the signal lines 75 is a conductor and extends linearly along the Z-direction inside the FPC 7. The plurality of signal lines 75 are parallel to each other. In FIGS. 13 to 15, for ease of explanation, the FPC 7 is illustrated as extending linearly in the Z direction; however, the FPC 7 may naturally be flexible.

As shown in an enlarged view of FIG. 15, each of the connection pads 76 is exposed on the connector connection surface 74, and the connection pads 76 are respectively connected to the signal lines 75 located inside the FPC 7. On each of the connector connection surfaces 74, the FPC 7 has eighteen connection pads 76 in correspondence with the number of the coaxial components 22 of the multi-core coaxial connector 2 to which the FPC 7 is connected. That is, on each of the connector connection surfaces 74, the connection pads 76 are arranged in a matrix of three rows by six pads. Among the component rows constituted by the connection pads 76 arranged in the X direction on each of the connector connection surfaces 74, a component row located closest to a transmission portion 72 is defined as a first row, a component row located outermost in the Z-direction is defined as a third row, and a component row located between the first row and the third row is defined as a second row.

On each of the connector connection surfaces 74, the connection pads 76 are connected to the signal pads 28, respectively, formed on the connection surface 201 of each of the multi-core coaxial connectors 2. By the connection between the connection pads 76 and the signal pads 28, the signal members 221 of the coaxial components 22 included in the multi-core coaxial connector 2 of the first connector assembly 10A and the signal members 221 of the coaxial components 22 included in the multi-core coaxial connector 2 of the second connector assembly 10B are connected to each other by the signal lines 75 of the FPC 7.

Referring to FIG. 16, the FPC 7 has a stripline structure. Specifically, the FPC 7 includes protective layers 721, resin layers 722, adhesive layers 723, and ground layers 724. Each of the protective layers 721 is an insulating film that covers a surface of the FPC 7 and protects an interior of the FPC 7. Each of the resin layers 722 is a base film of an insulator located between one of the ground layers 724 and one of the adhesive layers 723, and is made of a polyimide resin. Each of the ground layers 724 is a copper film located outward of the signal lines 75 in a lamination direction or Y-direction. Each of the adhesive layers 723 is made of an adhesive. One of the adhesive layers 723 is interposed between the resin layer 722 and the ground layer 724, thereby bonding these layers together. Another one of the adhesive layers 723 is interposed between the resin layer 722 and the signal lines 75, thereby bonding these layers together. The materials of each layer described above are examples, and the materials of each layer are not particularly limited.

In the aforementioned stripline structure, all of the plurality of signal lines 75 are located on a positive Y-side of the resin layer 722A positioned at a center of the FPC in the Y-direction. That is, in the FPC 7, the plurality of signal lines 75 are all formed on a common layer. Such routing of the signal lines 75 is realized by the arrangement of the coaxial components 22 in the multi-core coaxial connector 2. As described in the first embodiment, the coaxial components 22 are arranged in the multi-core coaxial connector 2 such that center positions of the coaxial components 22 do not overlap with each other in the X-direction. With such an arrangement, each of the signal lines 75 connecting the signal members 221 of the two multi-core coaxial connectors 2 does not interfere with any other signal lines 75 even when all signal lines are routed linearly along the Z-direction on the same layer. Therefore, in the structure 101, the FPC 7 having the stripline structure with reduced crosstalk characteristics can be applied. In the example shown in the drawings, the stripline structure is illustrated; however, the structure of the FPC 7 is not limited to the stripline structure, but may be a microstripline structure or a coplanar waveguide structure.

As is apparent from the enlarged view of FIG. 15, the plurality of signal lines 75 of the structure 101 have path lengths equal to each other. Specifically, the signal lines 75 connected to the connection pads 76A in the first row on the first connector connection surface 74A are connected in a one-to-one correspondence to the connection pads 76C in the third row on the second connector connection surface 74B. The signal lines 75 connected to the connection pads 76C in the third row on the first connector connection surface 74A are connected in a one-to-one correspondence to the connection pads 76A in the first row at the second connector connection surface 74B. Similarly, the signal lines 75 connected to the connection pads 76B in the second row on the first connector connection surface 74A are connected in a one-to-one correspondence to the connection pads 76B in the second row at the second connector connection surface 74B. All of these signal lines 75 have the same path length.

In the structure 101, since the coaxial components 22 of the multi-core coaxial connector 2 are arranged in the arrangement shown in the first embodiment, it is not necessary to bend and route the signal lines 75 so as to prevent them from interfering with each other even when the plurality of signal lines 75 are formed on the same layer. The signal lines 75 can be routed linearly along the Z-direction. Therefore, equal-length routing as shown in the enlarged view of FIG. 15 is possible. By equalizing the path lengths of the signal lines 75, delays of signals transmitted through the respective signal lines 75 can also be equalized.

### Third embodiment

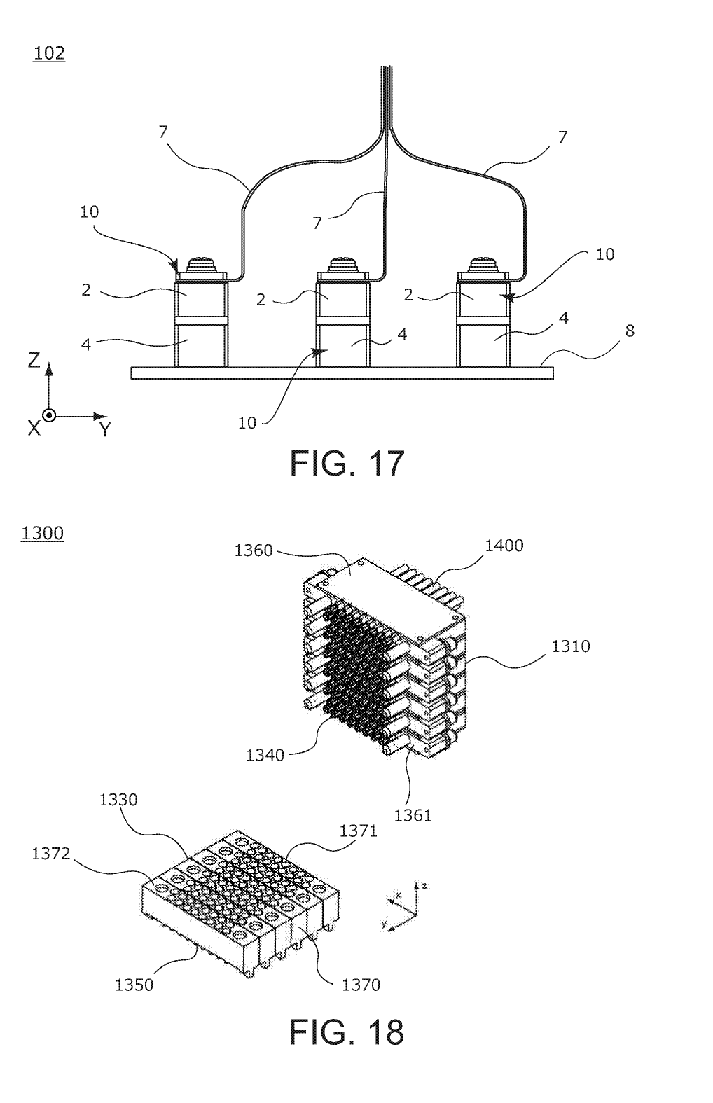

Referring to FIG. 17, a structure 102 according to a third embodiment of the present invention includes a mounting board 8, three connector assemblies 10 each shown in the first embodiment, and a plurality of FPCs 7. The mating connectors 4 of the respective connector assemblies 10 are all fixed on the mounting board 8. Each of the multi-core coaxial connectors 2 mates with the corresponding mating connector 4 fixed on the mounting board 8.

The plurality of FPCs 7 are connected to the multi-core coaxial connectors 2, respectively. At least portions of all the FPCs 7 are overlapped with each other and are arranged in proximity to each other. The portions of the FPCs 7 may be in close contact with each other, or may be arranged in proximity to each other without contacting each other by interposing another member between the FPCs 7. As described above, as the structure 102 includes the multi-core coaxial connectors 2 suitable for connection to the FPCs 7, a space for installing the structure 102 can be significantly reduced as compared with a case in which coaxial cables are used.

Although the present invention has been described above with reference to the embodiments, the present invention is not limited to the embodiments described above, and various modifications and changes may be made without departing from the spirit of the present invention.

For example, each of the multi-core coaxial connectors 2 illustrated in the first to third embodiments described above is a receptacle connector which includes the socket-shaped signal members 221. However, the multi-core coaxial connector of the present invention is not limited to a receptacle connector but may be a plug connector which includes pin-shaped signal members. In each of the first to third embodiments, connection of the FPC 7 to the multi-core coaxial connector 2 is illustrated. However, the multi-core coaxial connector of the present invention is not limited thereto but may be mounted on or connected to a substrate other than FPC.

Further, in the first to third embodiments, conductors such as copper are exemplified as materials for the signal members (221, 421), the ground members (223, 423), the ground housings (20, 40), the signal lines 75, the ground layers 724, and the like. However, the materials of these members are not necessarily limited thereto. For example, these members may be made of other metallic materials such as cupronickel, or may be made of superconducting materials such as a niobium–titanium alloy (Nb–Ti). Materials of the respective layers laminated inside the FPC 7 are also not particularly limited. For example, the protective layers 721 may include a plating layer such as a gold (Au) plating layer. The resin layers 722 serving as base films may be made of liquid crystal polymer, polyethylene terephthalate, fluororesin, or the like, instead of polyimide resin.

Further, in each of the first to third embodiments, the ground housing 20 holding the coaxial components 22 is formed as a single component. However, the present invention is not limited thereto, and the ground housing of the multi-core coaxial connector may comprise a combination of a plurality of components.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A multi-core coaxial connector comprising n component rows, n being a natural number of three or more, wherein:
each of the component rows comprises m or more coaxial components, m being a natural number of n or more,
the coaxial components in each of the component rows are arranged linearly at a predetermined pitch along a predetermined direction perpendicular to a longitudinal direction of the coaxial component, and
in the predetermined direction, between a center of one of the coaxial components in one of the component rows and a center of another one of the coaxial components adjacent thereto in the same component row, a center of one of the coaxial components in each of all other component rows is located.

2. The multi-core coaxial connector as recited in claim 1, wherein:
the multi-core coaxial connector comprises a connection surface connectable to a substrate,
the connection surface comprises a plurality of ground pads and a plurality of signal pads,
each of the coaxial components comprises a signal member, an insulator, and a ground member,
in each of the coaxial components, the signal member and the ground member are insulated from each other,
the ground pads are connected to the ground members,
the signal pads are connected to the signal members,
at least two ground pads among the plurality of ground pads are located away from each other with a groove left between, the groove extending to an edge of the connection surface,
n signal pads among the plurality of signal pads correspond to one of the coaxial components in each of the n component rows, and
each of the n signal pads is located within the groove between the two ground pads.

3. The multi-core coaxial connector as recited in claim 2, wherein:
the multi-core coaxial connector comprises a ground housing that holds a plurality of the coaxial components,
the ground housing is connected to the ground members of the coaxial components, and
the connection surface is primarily defined by one surface of the ground housing.

4. A structure comprising an FPC and two multi-core coaxial connectors, each of which is as recited in claim 1, wherein:
the FPC comprises a plurality of signal lines formed on a common layer and has one of a stripline structure, a microstrip line structure, or a coplanar line structure,
the coaxial components included in each of the multi-core coaxial connectors comprise signal members, insulators, and ground members, respectively, and
the signal members of the coaxial components included in one of the two multi-core coaxial connectors are respectively connected to the signal members of the coaxial components included in a remaining one of the two multi-core coaxial connectors via the signal lines of the FPC.

5. The structure as recited in claim 4, wherein:
the plurality of signal lines have path lengths equal to each other.

6. A structure comprising a mounting board, a plurality of connector assemblies, and a plurality of FPCs, wherein:
each of the plurality of connector assemblies comprises the multi-core coaxial connector as recited in claim 1 and a mating connector thereof,
the mating connectors of the connector assemblies are fixed on the mounting board,
in each of the connector assemblies, the multi-core coaxial connector is mated with the mating connector,
the plurality of FPCs are connected to the multi-core coaxial connectors, respectively, and
the plurality of FPCs at least partially overlap each other and are arranged in proximity to each other.
